(19) United States
(12) Patent Application Publication
(10) Pub. No.: US 2008/0083512 A1
(43) Pub. Date: Apr. 10, 2008

(54) Cord-Channeling Spool for a Cord Reel Assembly

(76) Inventor: Mu-Chuan Hsu, Rende Township (TW)

Correspondence Address: Dr. BANGER SHIA;Int''l Patent Office of Bang Shia, 102 Lindencrest Ct, Sugar Land, TX, 77479-5201, US

(21) Appl. No.: 11/532,086

(22) Filed: Sep. 14, 2006

(51) Int. Cl. E06B 9/30

(52) U.S. Cl. 160/170

(57) ABSTRACT

The present invention overcomes the problem of the high friction and the interference fit on the wind-up spool due to the cords wound up on it. This is accomplished by implementing a spool shaped like a hollow cylinder except for the two parallel side sections perpendicular to the otherwise circular cross sections, defining a hollow inner chamber, two parallel rectangular surfaces, and two otherwise cylindrical surfaces. The two rectangular surfaces span over the sides of the spool, acting as a friction-reducing buffer between the spool and the cords. By having the diameter of the inlet and the hole configured in relation to the diameter of one end of the cord associated with the spool, the cord engage with the spool by such an end.

### BACKGROUND OF THE INVENTION

1. Field of the Invention

The present invention relates to a spool and its associated cords for a cord reel assembly for retrieving or relieving the cords. In particular, it relates to a simply constructed spool mounting over a seat in a conventional cord reel assembly to reduce the high friction of the cords on the spool, and thereby reduce the chances of cords being over-wrap during operation. The present invention is a further improvement of the applicant's previous invention embodied in a co-pending application of Ser. No. 11/114,852.

2. Description of the Prior Art

A conventional cord seat assembly comprises a seat, and a spool around which a cord is wound around in a retrieving or releasing direction for moving an object such as a Venetian blind. The raising and lowering of the blind is done by a lift cord attached to the bottom rail or bottom slat, etc. The prior art reveals a general method for accumulating lift cords within a Venetian blind headrail. One method is to wind the lift cords onto spools. This method suffers a disadvantage that the cords do not wind evenly onto their respective spools.

A preferred method proposed in the prior art is to accumulate the cords onto a shaft that moves laterally, or traverses, so that the lift cord wind in a single layer onto the shaft. This insures even winding of each of the lift cords, and it maintains a constant mechanical advantage. Several methods have been used to produce the traversing of the rod. A rack and gear arrangement has been used. U.S. Pat. No. 1,343,527 reveals a lead screw and nut to accomplish the traversing. Another method, one that is free of any gears or lead screws, is revealed in U.S. Pat. No. 4,625,012 in which the lift cords, acting on cam features of their supporting cradles, produce the lateral forces to traverse the rod. The cord seat assembly of Anderson et al (U.S. Pat. No. 6,536,503) includes a substantially cylindrical winding section around which the cord is wound (shown in FIGS. 120-121). Still, many of the methods use a large number of complex parts and are difficult to adjust.

The disadvantage associated with a cord reel assembly is further described below using FIG. 7, which illustrates a conventional cord sear assembly, comprising a substantially cylindrical spool 2′ mounted over a seat 1′. The seat 1′ includes an axial hole 11′ at each end of the seat 1′, through which an axle 21′ integral with the spool 2′ extends. The seat 1′ further includes a through hole 12′ at the bottom of the seat 1′, through which the cord 3′ runs. A coupling section 22′ is configured at the far end of the spool 2 away from the through hole 12′, to which an end of the cord 3′ is fixed. Formed on the end of the spool 2′ near the through-hole 12′ is a conic guiding section 22′. When the spool 2′ is turned in a retrieving direction of the cord 3′, the cord 3′ is wound around the spool 2′ and moves toward the coupling section 22′. The conic guiding section 23′ is provided for preventing a section of the cord 3′ from overlapping on top of the other section and getting stuck during operation.

The disadvantage associated with the above-mentioned conventional cord reel assembly is that to accommodate the non-compliant shape of the conic guiding section 23′ within the seat, the size of the seat 1′ is inevitably increased, making the cord reel assembly bulky in appearance and also limited in application.

### SUMMARY OF THE INVENTION

It is therefore the goal of this invention to provide some feasible solutions for the shortcomings encountered in the prior arts at a low manufacture cost, and at the same time, to achieve a maximum degree of even winding of the cord. For the convenience of users, the present invention embodies the idea of cord channeling in the unique structure of the spool without resorting to extra gadgets to be assembled.

The preferred embodiment in accordance with the present invention features a cord reel spool with three main components: (1) a spool with four surfaces contacting the cord for better channeling, (2) an axle running through the hollow inner chamber defined by the spool and mounting over a seat, and (3) a cord attached to the spool and the material for lifting and lowering. Accordingly, a cord reel assembly can be made with the three components proposed in the present invention plus a conventional cord reel seat which supports the spool.

The spool in the present invention is shaped like a pipe having a semi-cylindrical and semi-rectangular shape, with an axle running through its hollow center. The axle is rotatably received by a conventional cord reel seat for being a cord reel assembly. The appearance of the spool in this invention is comparable to a substantially cylinder having a larger circular cross section on one end, and a smaller circular cross section on the other, with its two sections perpendicular to its circular cross sections cut off. Therefore, the spool is semi-cylindrical and semi-rectangular in that the cross section area at any point along the pipe can be described as a rectangle with two flatten semi-circles on its top and its bottom. In sum, the surface of the spool contacting the cord includes two cylindrical surfaces and two rectangular surfaces. The rectangular contact surface acts as a buffer between the cord and the spool around which the cord is wound up, reducing the friction between the spool and the cord.

On each of its cylindrical outer surfaces contacting the cord, the spool further includes a cord-spool meet hole. The cord-spool meet hole opens further to a cord-clamping inlet, which has a smaller diameter than that of the cord. Furthermore, the cord associated with the spool has an end of which the diameter is larger than that of the rest of the cord. In assembling the cord with the spool, the larger end of the cord is first dropped into either of the two cord-reel meet holes, and then moved to the bordering inlet for being clamped inside there and hence engaging the spool.

The advantages of this simply structured spool will become more apparent to those of ordinary skilled in the art upon reading the following descriptions in conjunction with the accompanying drawings.

### BRIEF DESCRIPTION OF THE DRAWINGS

FIG. 1 is a perspective view of a spool in accordance with a preferred embodiment of this invention.

FIG. 1A is a partial enlargement of the cord-reel meet hole and its bordering inlet.

FIG. 2 is a side view of the spool in FIG. 1.

FIG. 3 is a cross sectional view of the spool in FIG. 1 in operation.

FIG. 4 is a perspective view of a cord reel assembly with the spool and cord in accordance with the present invention.

FIG. 5 is a cross sectional view of the spool in FIG. 1 operating in a clockwise retrieving direction.

FIG. 6 is a side view of the spool in FIG. 1 in a retrieving mode, mounted over a conventional cord seat.

FIG. 7 illustrate a conventional cord reel assembly.

FIG. 8 is a cross sectional view of the cord reel assembly in FIG. 7 operating in a clockwise retrieving direction.

### DETAILED DESCRIPTION OF THE INVENTION

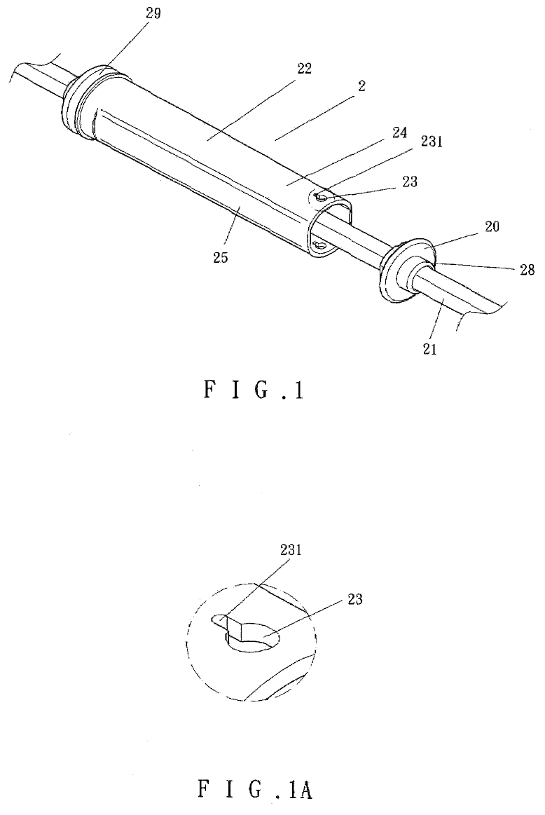

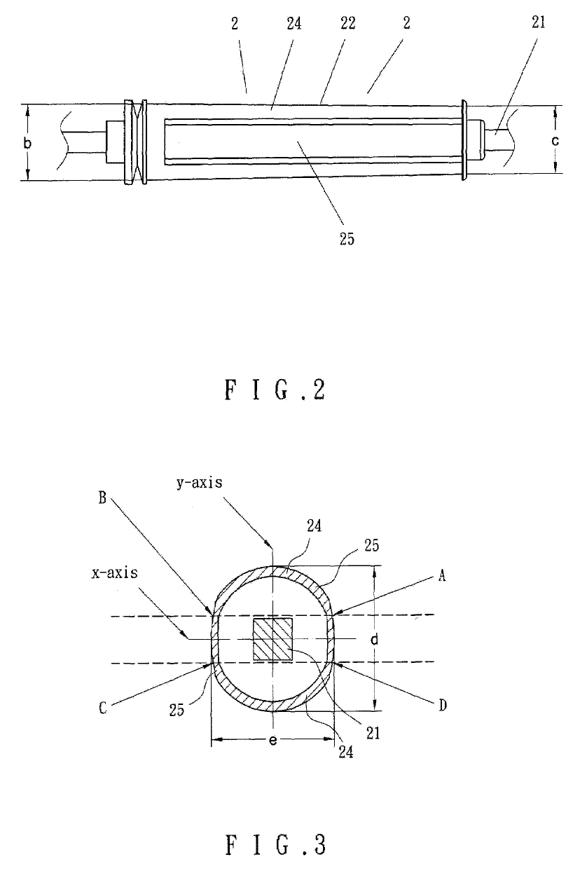

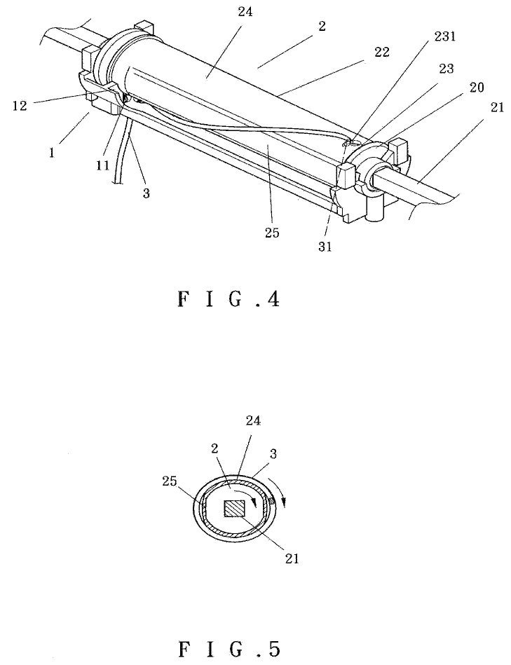

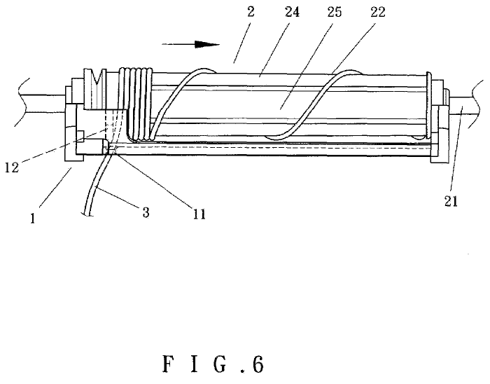

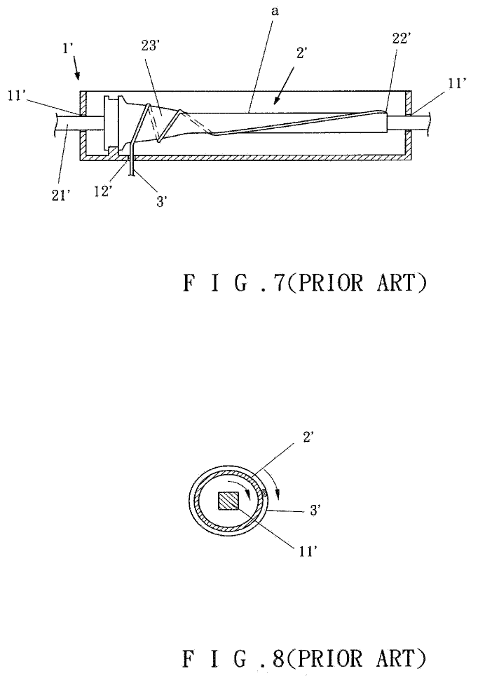

Referring to FIG. 1 and FIG. 4, a spool in accordance with the present invention includes three main components: a spool body 2, an axle 21, and a cord 3 associated with the spool. The spool body 2 has an outer surface 22′ contacting the cord. The idea of cord channeling is implemented in the unique shape of the spool body 2. FIG. 2 shows that the diameter b of the cross sectional area on one side of the spool 2 is larger than the diameter c of the cross sectional area on the other side. In short, the outer appearance of the spool body 2 is like a hollow cylinder starting with a cross section area of a larger radius on one side, and ending in a cross section area of a smaller radius on the other, with the two sections of the cylinder perpendicular to its circular cross sections symmetrically cut off. As a result, there are four different surface areas of the spool body 2 for contacting the cord. Two are in rectangular shape, indicated by the cord-reel shoulder 25; and the other two, in an otherwise cylindrical shape, indicated by the semi-cylindrical surface 24. The two rectangular surfaces act as a buffer between the spool and the cords to reduce the friction forces from the accumulating cords on the spool during operation. It is to be noticed that to be successfully received in the seat 1, the rectangular surface 25 allows for some cylindrical margin at one side of the spool 2 near the end disk 29.

To rotatably mount over a conventional seat 1, a circular end disk 29 is formed on one side of the spool body 2 with larger cross sectional areas; likewise, a smaller circular end disk 20 is also formed with the axle 20 on the side of the spool with smaller cross-sections. Both the end disk 29 and 20 are integral with a hollow circular shaft 28 on the outward side facing away from the spool body 2 for better attachment to the axle 21. As a result, the end disk 29 is received in the seat 1 of a conventional cord seat bordering the end wall 12 of the seat 1. In a similar way, the end disk 20 is received in the other end of the seat 1.

On its two semi-cylindrical or otherwise cylindrical surfaces 24 contacting the cords, the spool further includes two cord-spool meet hole 23. Each cord-spool meet hole 23 further opens to a smaller cord-clamping inlet 231, which has a smaller diameter than that of the cord. To be more specific, the cord 3 is configured to have an end 31 of which the diameter is larger than that of the rest of the cord, also larger than that of the cord-clamping inlet 231, but smaller than that of the cord-spool meet hole 23. As a result, in assembling the cord 3 with the spool 2, the larger end 31 of the cord 3 is first dropped into either of the cord-spool meet hole 23, and then positioned to the clamping inlet 231 for engaging to the spool. The other end of the cord 3 extends through the through-hole 11 of the seat 1 and attached to a material to be lifted or lowered, as shown in FIG. 1.

FIG. 3 illustrates the unique shape of the spool 2 in terms of its otherwise circular cross sectional areas. The x-axis and y-axis in FIG. 3 intersects at the center of the spool body 2, where the axle 21 houses. A, B, C, and D in FIG. 3 each represent the contact region between the rectangular surface 25 and the otherwise cylindrical surface 24 of the spool body 2. The rectangular surface area 25 is defined as the area between the two horizontal dashed lines in FIG. 3, or more specifically, the area between A and D, and also the area between B and C; while the otherwise cylindrical area are indicated by the area between A and B, and also the area between C and D.

The A, B,. C, and D in FIG. 3 could represent a point, indicating a sharp contact between surface 25 and surface 24. Preferably, A, B, C, and D each represents a smooth transitional interface between surface 25 and surface 24 to facilitate movements of cords.

For the present invention, the distance between the two rectangular surfaces 25 along the x-axis is preferably to be less than that between the two otherwise cylindrical surfaces 24 along the y-axis. That is, the value of e in FIG. 3 is to be smaller than that of d.

I claim:

1. A spool for a cord reel assembly for winding up or letting out materials comprising:
(a) a spool body, shaped like a hollow cylinder except for the two parallel side sections perpendicular to the otherwise circular cross sections, defining a hollow inner chamber and two otherwise cylindrical outer surfaces;
wherein each of said two parallel side sections form a rectangular shoulder, spanning over said body in parallel and allowing a reasonably margin for mounting over a conventional seat;
on one end of said body is formed an end wheel to be received in a conventional seat; said end wheel is integral with a hollow circular shaft on the outward side facing away said body;
on each of said otherwise cylindrical outer surfaces is formed a cord-spool meet hole; wherein said cord-spool meet hole further opens to a cord clamping inlet with a radius smaller than that of said cord-spool meet hole;
(b) an axle running through said hollow inner chamber along which said body rotates for reeling the material; wherein on one end of said axle is formed an end disk to be received in a conventional seat; said end disk is integral with a hollow circular sleeve on the outward side facing away said body; and
(c) a cord configured with a larger end, of which the diameter is larger than that of the rest of the cord, also larger than that of said cord-clamping inlet, but smaller than that of said cord-spool meet hole such that said larger end of said cord can get into either of said cord-spool meet hole, and be positioned to said cord clamping inlet for engaging said spool body.

2. The claim as claimed in claim 1, wherein the diameter of the otherwise circular cross sections of said body decreases from one end to the other end of said body.

3. The claim as claimed in claim 1, wherein the contact region between said rectangular shoulder and said otherwise cylindrical surfaces is configured as a smooth transitional interface.
